(19) United States
(12) Patent Application Publication
(10) Pub. No.: US 2016/0280130 A1
(43) Pub. Date: Sep. 29, 2016

(54) WHEEL IMPACT SENSING AND DRIVER WARNING SYSTEM

(71) Applicant: GM GLOBAL TECHNOLOGY OPERATIONS LLC, Detroit, MI (US)

(72) Inventors: HAMID G. KIA, BLOOMFIELD HILLS, MI (US); WILLIAM R. RODGERS, BLOOMFIELD TOWNSHIP, MI (US)

(21) Appl. No.: 14/667,912

(22) Filed: Mar. 25, 2015

(51) Int. Cl. B60Q 9/00; G07C 5/08

(52) U.S. Cl. CPC B60Q 9/00; G07C 5/08

(57) ABSTRACT

A wheel impact sensing system of a vehicle includes at least one sensor measuring an acceleration of a vehicle wheel resulting from an impact to the vehicle wheel. A processor determines a severity of the impact to the vehicle wheel as function of the acceleration measurement. An output device alerts a driver to potential damage of the vehicle wheel based on the determined impact severity to the vehicle wheel.

### BACKGROUND OF INVENTION

An embodiment relates to wheel impact sensing.

Wheel impacts caused by various road conditions such as potholes can cause significant damage to a vehicle wheel. Based on the force of the impact and other factors, the tire can actually deflect so as to cause the wheel to make contact with the road surface (e.g., edge of a pothole) resulting in damage to the wheel such as a bent rim. In many instances, the damage to the wheel is on the inner rim which is not readily noticeable unless an observer is able to get under the vehicle to observe any damage or take the wheel off. Moreover, after the impact occurs, unless a driver of the vehicle notices that the vehicle is not handling the road properly after the impact, a driver may be unaware of any damage to the vehicle wheel. Often, the driver will continue driving and will forget about the impact if no immediate changes in vehicle handling are noticed by the driver. However, damage to the wheel may result in gradual tire pressure changes, or an already bent rim may be susceptible to a seal breaking if another impact (and even one of a lesser severity than the first) occurs which could cause immediate instability to the vehicle. Therefore, driver awareness would be beneficial where impacts have occurred that have likely caused damage to the vehicle wheel.

### SUMMARY OF INVENTION

An advantage of an embodiment is the determination of a severity of impact to a wheel of a vehicle and notification to the driver. A wheel impact sensing system utilizes sensors to sense accelerations at the wheels of a vehicle. The system determines a severity of an impact based on the acceleration data obtained by the sensors. The driver of the vehicle is alerted to the potential damage to the vehicle wheels. The severity of the impact is determined by comparing the acceleration data to a predetermined threshold. Other factors that are used in cooperation with the acceleration data for assessing a severity of the impact to the vehicle wheel may include, but are not limited to, the radial length of the tire and the air pressure loss from the vehicle tire since the impact. The system compares the acceleration data and/or tire pressure data, and based on what threshold at the assessed threshold level of the impact, an associated severity warning may be output by an output device such as a driver notification device which may be a visual warning, an audible warning, or a haptic warning including the specific wheel to inspect. The warning may be a generic warning or may use a specific warning that identifies a level of urgency for inspecting the wheel.

An embodiment contemplates a wheel impact sensing system of a vehicle. At least one sensor measures an acceleration of a vehicle wheel resulting from an impact to the vehicle wheel. A processor determines a severity of the impact to the vehicle wheel as function of the acceleration measurement. An output device alerts a driver to potential damage of the vehicle wheel based on the determined impact severity to the vehicle wheel.

An embodiment contemplates a method of sensing an impact to a wheel of a vehicle comprising the steps of measuring, by at least one sensor, an acceleration of a vehicle wheel resulting from an impact to the vehicle wheel. Determining, by a processor, a severity of the impact to the vehicle wheel based on the acceleration measurement of the vehicle wheel. Alerting a driver, by an output device, to potential damage of the vehicle wheel based on the determined impact severity to the vehicle wheel.

### BRIEF DESCRIPTION OF DRAWINGS

FIG. 1 is a pictorial illustration of a vehicle equipped with a wheel impact sensing and driver warning system.

FIG. 2 is an exemplary illustration utilizing a wheel-based acceleration sensor configuration.

FIG. 3 is an exemplary illustration utilizing a central vehicle-based acceleration sensor configuration.

FIG. 4 is a flowchart of a first technique for monitoring wheel impact and driver warning.

FIG. 5 is a flowchart of a second technique for monitoring wheel impact and driver warning.

FIG. 6 is a flowchart for utilizing a redundancy sensor check.

### DETAILED DESCRIPTION

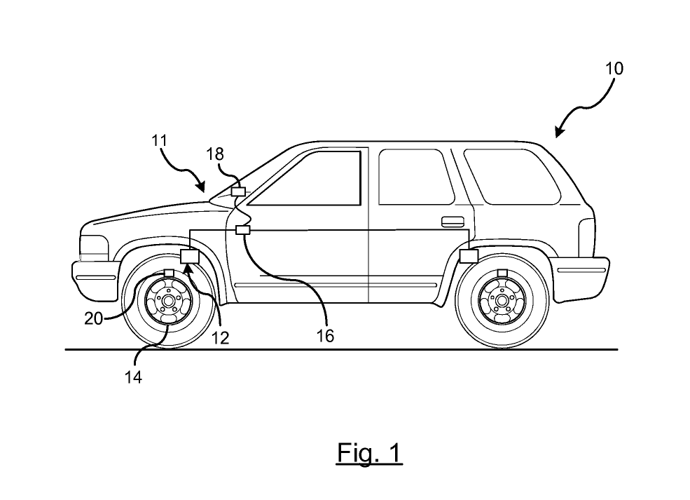

FIG. 1 illustrates a vehicle 10 equipped with a wheel impact sensing and driver warning system 11. The vehicle includes at least one wheel acceleration sensor 12 coupled to the vehicle for sensing an impact to one of the vehicle wheels 14.

Accelerations sensed by the at least one wheel sensor 12 are transmitted to a processor 16 where a determination is made whether the impact force is greater than a force threshold. The processor 16 may be a dedicated processor or may be a shared processor utilized by another subsystem.

The vehicle 10 further includes an output device 18 in communication with the processor 16 for alerting the driver to a wheel impact condition.

The vehicle may further include tire pressure monitoring sensors 20 disposed within each tire that is used in cooperation with the wheel acceleration sensors 12 for determining the impact. Data obtained from each tire pressure sensor is wirelessly communicated to the processor 16 where the data is cooperatively utilized with the wheel impact sensing data for determining a severity of the impact to the vehicle wheel.

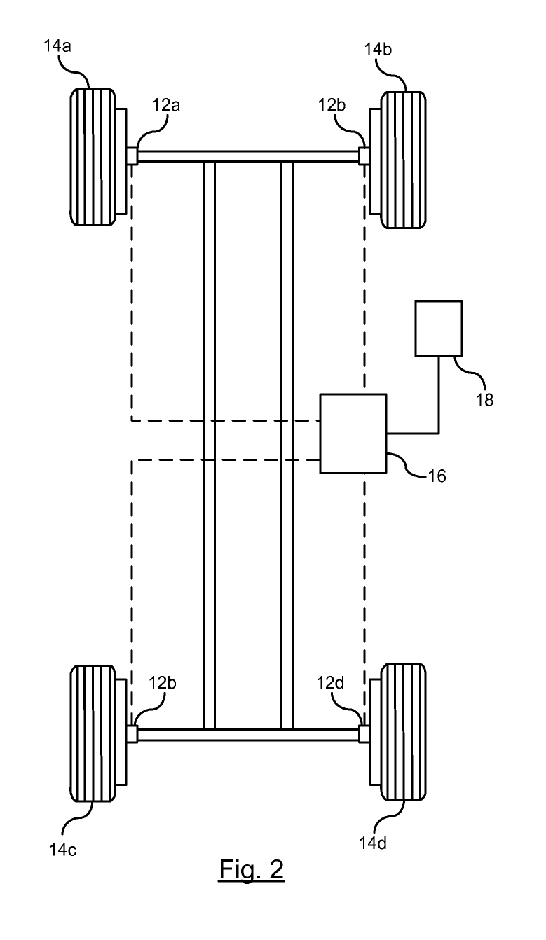

FIG. 2 illustrates a first configuration utilizing a respective wheel acceleration sensor disposed at each respective wheel. The plurality of wheel acceleration sensors include a first wheel sensor 12a disposed at a first wheel 14a, a second wheel sensor 12b disposed at a second wheel 14b, a third wheel sensor 12c disposed at a third wheel 14c, and a fourth wheel sensor 12d disposed at a fourth wheel 14d.

The plurality of wheel sensors are preferably longitudinal accelerometers that detect and measure a vertical impact to a respective vehicle wheel for detecting a G-force applied to each vehicle wheel. The plurality of sensors may be mounted to components that include, but are not limited to, a half shaft of the axle, anti-lock braking system, the axle itself. Each longitudinal sensor will monitor G-force conditions at an associated wheel and provide acceleration data to the processor 16 for determining a severity of impact to one or more of the vehicle wheels. Longitudinal wheel sensors are typically unsprung mass sensors and therefore provide a more true representation of the impact to a wheel since filtering is not required.

Alternatively, the plurality of sensors may include vertical acceleration sensors or inertial sensors for sensing vertical displacement of the wheel. Vertical acceleration sensors may include a spring mass which may result in finite seismic resonances being produced which may skew the integrity of the output signals. Some filtering may then be applied to the outputs from spring mass sensors to remove such resonances.

As shown in FIG. 2, each of the respective wheel acceleration sensors 12a-d is in communication with the processor 16. The communication may be via a wireless communication or via a wireline communication. The process is in communication with the output device 18 for alerting the driver as to the impact to the vehicle wheel.

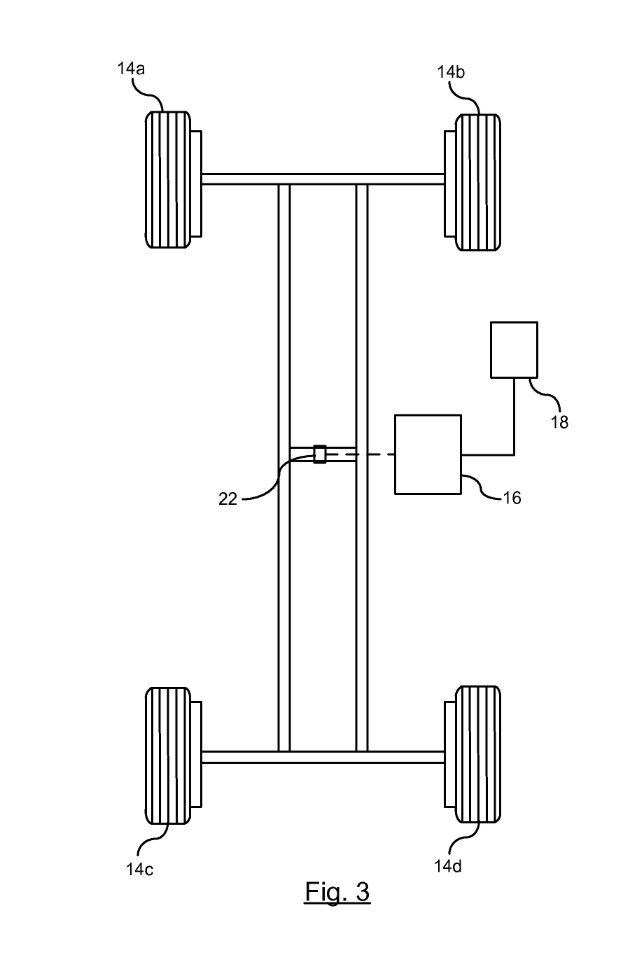

FIG. 3 illustrates a configuration where a central sensor unit 22 is used to sense for an impact to the vehicle wheels 14a-d. In this configuration, the central sensor unit 22 may include one or more sensors utilized by a stability control unit that senses the yaw, pitch, roll, lateral, or longitudinal motions of the vehicle. The central sensor unit 22 is typically mounted close to the center of the vehicle and may be mounted to the cab or the frame of the vehicle.

The central sensor unit 22 communicates with the processor 16 for supplying data relating to the various movements of the vehicle. While the central sensing unit 22 has the advantage of utilizing a single device utilized by other subsystems of the vehicle, which the data may be obtained from, the central sensing unit 22 may only provide data as to a general G-force impact to the vehicle as opposed to identifying which exact wheel of the vehicle received the impact force. Moreover, having a unit mounted on the frame or the body of the vehicle may have reduced sensitivity as opposed to a direct wheel mount since a vehicle's suspension system may absorb some of the impact thereby diminishing the severity of the impact. However, correlation data relating to the impact may be derived by test data obtained from various sensors disposed throughout the vehicle (e.g., wheels, frames, body) sensing a same impact. The resulting G-force recorded by each sensor are correlated to one another, such that the G-force result obtained for a body mounted sensor may be correlated with the G-force result obtained for wheel mounted sensors.

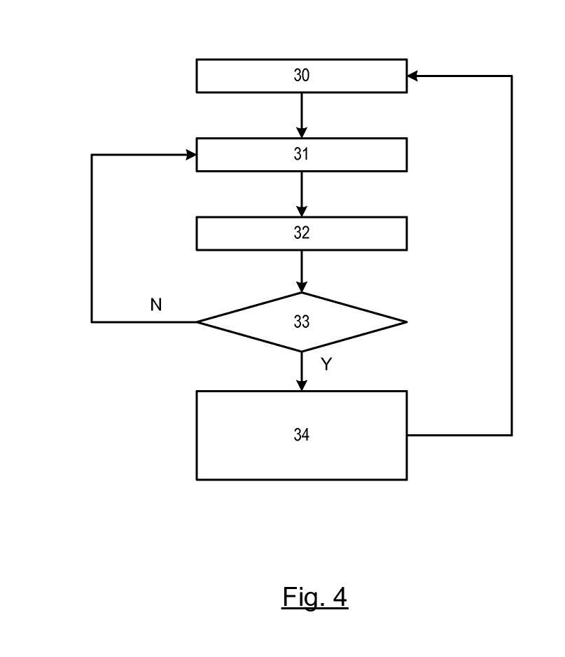

FIG. 4 illustrates a flowchart for monitoring a wheel impact and determining whether to issue a warning to a driver of the vehicle.

In step 30, the monitoring system including the sensors is initialized. This may include re-zeroing the sensors.

In step 31, the sensors are enabled for sensing forces exerted on the vehicle wheels. The sensors will obtain data and communicate the data to the processor for determining a G-force impact to the vehicle wheels.

In step 32, the G-force impact to the vehicle wheels is determined based on the received data by the sensors. A determination is made for each wheel if sensors are utilized at each wheel, or alternatively a single G-force determination is made if a central sensor unit is utilized.

In step 33, data obtained by the sensors are received by the processor and a routine is executed for determining whether the G-force exerted on any of the vehicle wheels exceed an impact threshold. The threshold may be setup in a lookup table previously constructed by test data. This may be constructed by testing different sized wheels and tires at different impact forces or may be constructed utilizing machine learning techniques. Since tires have different sized radial lengths, tires having different radial lengths exhibiting a same G-force impact may result in different damage to the wheel (e.g., low profile tires have shorter radial lengths). A same G-force may affect the severity of the impact to vehicle having different tire sizes. As a result, a lookup table may be utilized that correlates the associated input G-force to an impact threshold based on the radial length of the tires. The lookup table or similar may be stored in the processor memory or some other memory storage device.

If a determination is made that the G-force exceeds a predetermined threshold, then the routine proceeds to step 34; otherwise a return is made to step 31 if the G-force does not exceed a threshold. As a result, the system will continue monitoring impacts to the vehicle wheels.

In step 34, a driver is alerted by an output device alerting the driver to check for wheel damage. The notification to the driver may be a visual warning, an audible warning, or a haptic warning. The warning may be a generic warning or may use a specific warning that identifies a level of urgency for inspecting the wheel based on the assessed severity of impact to the vehicle wheel. For example, if the processor determines the G-force exceeds a maximum threshold, a warning may be output suggesting that the driver immediately pull over and inspect a respective vehicle wheel. If the G-force is between a minimum threshold for issuing an alert and the maximum threshold, then a less urgent warning may be output that recommends that a vehicle wheel be inspected in the near future or when the vehicle is parked. A return is made to step 31 to continue monitoring wheel impacts.

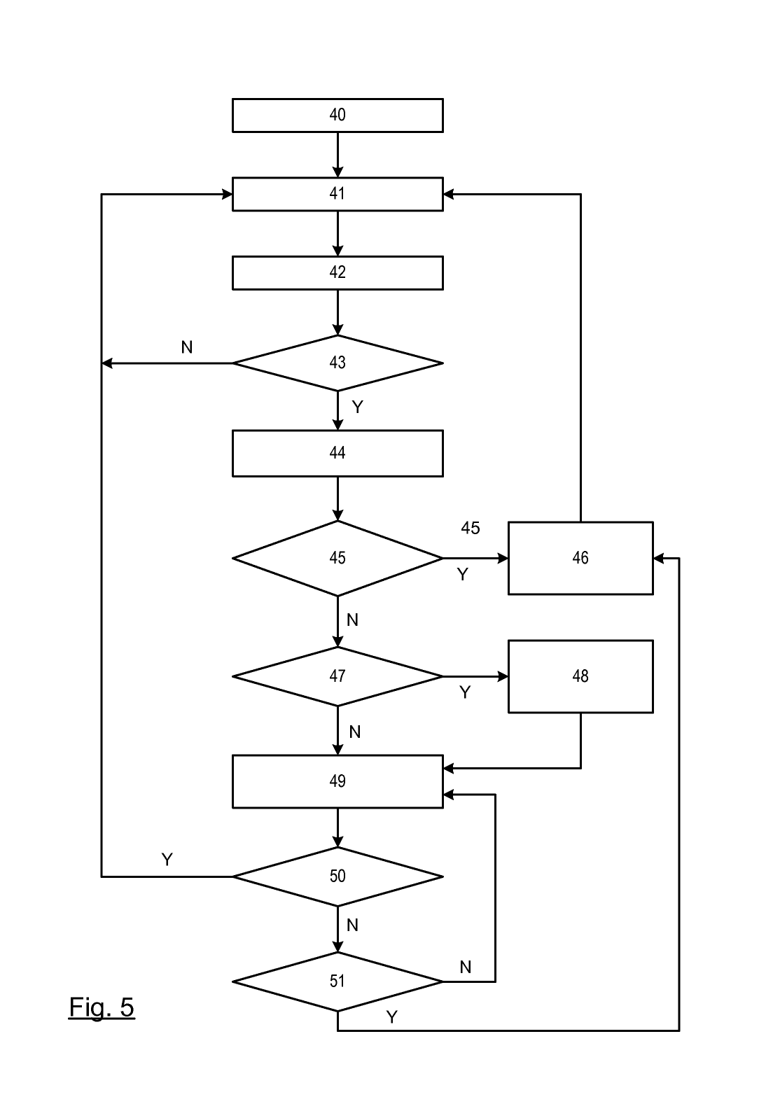

FIG. 5 illustrates a flowchart for determining whether to issue a warning to a driver of the vehicle-based on monitoring a wheel impact force and tire pressure monitoring.

In step 40, the monitoring system including the sensors is initialized. This may include re-zeroing the sensors.

In step 41, the sensors are enabled for sensing forces exerted on the vehicle wheels. The sensors will obtain data and communicate the data to the processor for determining a G-force impact to the vehicle wheels.

In step 42, the G-force impact to the vehicle wheels is determined based on the received data by the sensors. A respective impact is assessed for each wheel where separate sensors are utilized at each wheel, or alternatively a single G-force assessment is made if a central sensor unit is utilized.

In step 43, data obtained by the sensors are received by the processor and a routine is executed for determining whether the G-force exerted on any of the vehicle wheels exceed an impact threshold. The threshold may be setup in a lookup table previously constructed by test data. This may be constructed by testing different sized wheels and tires at different impact forces or may be constructed utilizing machine learning techniques. Since tires have different sized radial lengths, tires having different radial lengths exhibiting a same G-force impact may result in different damage to the wheel (e.g., low profile tires have shorter radial lengths and therefore the tire does not need as much displacement for the ground surface to contact the wheel). A same G-force applied to the vehicles having different radial length tires may result in different damage to the wheels. As a result, a lookup table may be utilized that correlates the associated input G-force to an impact threshold based on the radial length of the tires. The lookup table or similar may be stored in the processor memory or some other memory storage device.

If a determination is made that the G-force exceeds a predetermined threshold, then the routine proceeds to step 44; otherwise a return is made to step 41 if the G-force does not exceed a threshold. If the routine determines that the G-Force does not exceed the predetermined threshold, then the routine returns to step 41 and will continue monitoring for impacts to the vehicle wheels.

In step 44, in response to the G-force signal being greater than the predetermined threshold, a tire pressure system check is initiated. Tire pressure sensing data obtained by each wheel mounted tire pressure sensing device is communicated to the processor. Alternatively, data that has been processed by the tire pressure monitoring system, if already in a useable format for the impact sensing system, may be provided to the processor as opposed to each wheel sending raw tire pressure data to the processor.

In step 45, a determination is made whether the impacted tire is losing tire pressure at a constant rate. If the determination is made that the tire is losing pressure at a constant rate, then the routine proceeds to step 46, where a warning is output to the driver of the vehicle to immediately check for damage to the vehicle wheel. If a system is utilized that includes a respective sensor at each wheel, then the system may identify which wheel is suspected of having the damage. A return is then made to step 41 to continue monitoring for wheel impacts. If the determination is made that the tire is not losing pressure at a constant rate, then the routine proceeds to step 47.

In step 47, a determination is made whether a respective tire lost a predetermined amount of pressure over a predetermined time. If the determination is made that a tire lost at least a predetermined amount of pressure over a predetermined time, then the routine proceeds to step 48 where a notification is output to the driver to check the vehicle wheel for damage when possible, and the routine proceeds to step 49. If the determination is made, in step 47, that the tire did not lose a predetermined amount of pressure over the predetermined time, then the routine proceeds to step 49.

In step 49, air pressure is monitored for a predetermined monitoring time period.

In step 50, a determination is made whether the predetermined monitoring period has expired. If the predetermined period of time has expired, and no pressure changes have been detected, then the routine proceeds to step 41 where the system is reset and the vehicle sensing for wheel impacts restarts. In step 50, if the determination is made that the predetermined monitoring period is not expired, then the routine proceeds to step 51.

In step 51, a determination is made whether an additional pressure drop is detected. If the determination is made that an additional pressure drop is detected, then the routine proceeds to step 46 where a warning is output to the driver. In step 51, if the determination is made that an additional pressure drop is not detected, then a return is made to step 49 to continue monitoring the tire pressure of the wheel for the remainder of the predetermined monitoring period.

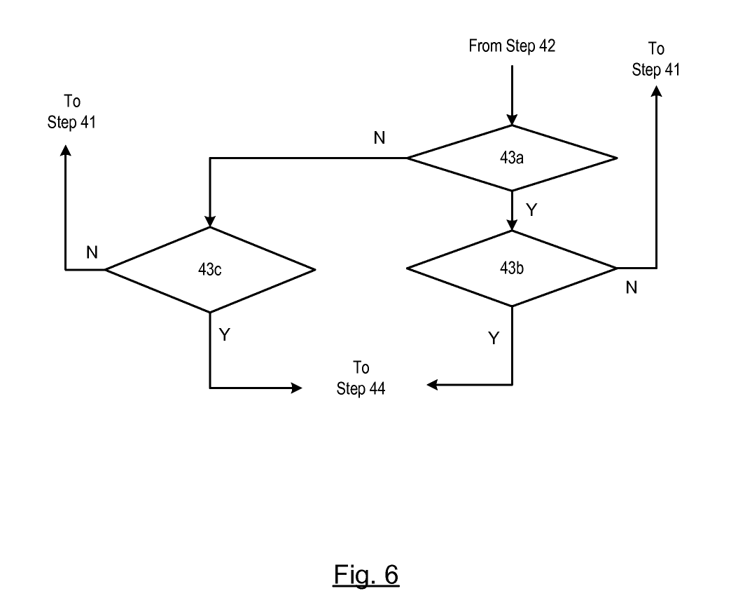

FIG. 6 illustrates a flowchart for determining whether to issue a warning to a driver of the vehicle-based on monitoring a wheel impact force and tire pressure monitoring utilizing a redundancy check for wheel impact sensing. This process utilizes the flowchart shown in FIG. 5 with the addition of the elements described below. To reduce duplicity of the flowchart, only steps 43a-c that describe the redundancy check will be described below which replace step 43.

In block 43a, a determination is made whether the G-force determined from a wheel sensor is greater than a predetermined maximum threshold value. If the determination is made that the G-Force threshold exceeds the predetermined maximum threshold value, then the routine proceeds to step 43b; otherwise the routine proceeds to step 43c.

In step 43b, in response to the G-Force exceeding the predetermined maximum threshold value, a determination is made whether an inertial sensor located elsewhere in the vehicle sensed the impact. As described earlier, the inertial sensor may be a sensor from another system such as, but not limited to, a stability control system. If the determination is made that the inertial sensor sensed the impact, then the routine proceeds to step 44 to initiate the tire system pressure check. If the inertial sensor did not sense the impact, then a conflict exists between both sensors. The rationale is that since the G-Force of the wheel impact sensor exceeded a maximum threshold, then it is assumed that the inertial sensor should have sensed this impact; however, since the inertial sensor did not sense an impact, then an issue is present with one of the sensors and therefore no warning is initiated since neither sensor can be validated. As a result, the routine will then return to step 41 to re-zero the sensors and re-initiate wheel impact sensing.

In step 43c, in response the determination that the G-Force did not exceed a predetermined maximum threshold, then a determination is made whether the G-Force threshold sensed by the wheel speed sensor is between the predetermined maximum threshold force and a predetermined minimum threshold force. If the G-force is less than the predetermined minimum threshold force, then the routine proceeds to step 41 to re-initiate the wheel sensing process. If the determination is made that G-Force is between the predetermined maximum and minimum thresholds, then the routine proceeds to step 44. A G-Force measurement between the predetermined minimum and maximum thresholds may not be sufficient enough to be sensed by the inertial sensor to make a redundancy check determination; however, this does not indicate that inertial sensor or wheel sensor is faulty. Rather, the G-Force may not be at a sufficient force for the inertial sensor to detect the impact to the wheel, which could be the result of a low impact force to the wheel or the suspension system may have dampened the impact force such that the inertial sensor could not detect the impact. As a result, the routine will proceed to step 44 and perform the tire pressure monitoring check to determine whether a tire pressure leak is occurring.

While certain embodiments of the present invention have been described in detail, those familiar with the art to which this invention relates will recognize various alternative designs and embodiments for practicing the invention as defined by the following claims.

1. A wheel impact sensing system of a vehicle comprising:
at least one linear sensor measuring a linear acceleration of a vehicle wheel resulting from an impact to the vehicle wheel;
a processor determining a severity of the impact to the vehicle wheel as function of the linear acceleration measurement;
an output device alerting a driver to potential damage of the vehicle wheel based on the determined impact severity to the vehicle wheel.

2. The system of claim 1 wherein the at least one sensor includes a plurality of longitudinal sensors each located at a vehicle wheel measuring accelerations of the vehicle wheel.

3. The system of claim 2 wherein the processor identifies which vehicle wheel incurred the impact.

4. The system of claim 1 wherein the output device outputs a warning to immediately inspect the vehicle wheel based on acceleration data being greater than a maximum threshold.

5. The system of claim 1 wherein the output device outputs a warning to inspect the vehicle tires based on the acceleration data being between a maximum threshold and a minimum threshold.

6. The system of claim 1 wherein the at least one sensor includes an inertial sensor for measuring accelerations of the vehicle wheel.

7. The system of claim 1 wherein the at least one sensor includes a central sensing unit disposed on the vehicle for measuring accelerations as a result of an impact to the vehicle wheels.

8. The system of claim 1 wherein the processor utilizes a lookup table to determine the severity of impact to the vehicle wheel as a function of the acceleration measurement.

9. The system of claim 1 wherein a radial length of a tire is utilized in cooperation with the acceleration measurement for determining the severity of impact to the vehicle wheel.

10. The system of claim 1 further comprising a tire pressure monitoring system, wherein the processor utilizes tire pressure data obtained by the tire pressure monitoring system in cooperation with the acceleration data to determine a severity of impact.

11. The system of claim 10 wherein the output device actuates a warning to immediately inspect the vehicle wheel for damage based on the acceleration data being greater than a predetermined impact threshold and the tire pressure data indicating tire pressure decreasing at a constant rate.

12. The system of claim 10 wherein the output device actuates a warning to inspect the vehicle wheel for damage based on the acceleration data being greater than a predetermined impact threshold and the tire pressure data indicating an aggregate tire pressure loss during a respective instance of time.

13. A method of sensing an impact to a wheel of a vehicle comprising the steps of:
measuring, by at least one sensor, a linear acceleration of a vehicle wheel resulting from an impact to the vehicle wheel;
determining, by a processor, a severity of the impact to the vehicle wheel based on the linear acceleration measurement of the vehicle wheel;
alerting a driver, by an output device, to potential damage of the vehicle wheel based on the determined impact severity to the vehicle wheel.

14. The method of claim 13 wherein the at least one sensor includes a plurality of longitudinal sensors each located at a vehicle wheel measuring accelerations of the vehicle wheel, and wherein the vehicle wheel incurring the impact is identified.

15. The method of claim 13 wherein the at least one sensor further includes an inertial sensor measuring accelerations through a body of the vehicle, wherein a redundant check is performed by determining whether the inertial sensor detected an impact to the vehicle, wherein if the determination is made that the acceleration sensed by a respective longitudinal sensor is greater than a maximum threshold and the inertial sensor detect the impact, then a tire pressure monitoring routine is applied for cooperatively determining a severity of the impact

16. The method of claim 13 further comprising the step of determining whether the acceleration is greater than a maximum threshold, wherein a warning is output to the driver to immediately inspect the vehicle tires in response to the acceleration being greater than a maximum threshold.

17. The method of claim 13 further comprising the step of determining whether the acceleration is between a maximum threshold and a minimum threshold, and wherein a warning to inspect the vehicle tires is output to the driver based on the acceleration being between a maximum threshold and a minimum threshold.

18. The method of claim 13 wherein the severity of the impact to the vehicle wheel is determined by a lookup table, the lookup table identifying the severity of impact as a function of the acceleration.

19. The method claim 18 wherein the severity of the impact is further determined as a function of a radial length of a tire of the vehicle.

20. The method of claim 13 further comprising the steps of:
obtaining tire pressure data from a tire pressure monitoring system;
determining the severity of impact as a function of the acceleration and the tire pressure data.

21. The method of claim 19 further comprising the step of determining that the tire pressure data indicates that the tire pressure is decreasing by a constant rate, wherein the output device actuates a warning to the driver to immediately inspect the vehicle wheel for damage based on the acceleration being greater than a predetermined impact threshold and the tire pressure data indicating tire pressure decreasing at the constant rate.

22. The system of claim 13 further comprising the step of determining that an aggregate tire pressure loss occurs over a respective period of time, wherein the output device actuates a warning to inspect the vehicle wheel for damage as a function of the acceleration being greater than a predetermined impact threshold and the tire pressure data indicating that the aggregate tire pressure loss occurs over the respective period of time.

23. The method of claim 13 wherein the at least one sensor includes wheel-based sensors each located at a vehicle wheel measuring accelerations of the vehicle wheel, wherein the vehicle wheel incurring the impact is identified, wherein the at least one sensor further includes an inertial sensor measuring accelerations through a body of the vehicle, wherein a redundant check is performed by determining whether the inertial sensor detected an impact to the vehicle, wherein if the determination is made that the acceleration sensed by a respective wheel-based sensor is greater than a maximum threshold and if the inertial sensor detects the impact, then a tire pressure monitoring routine is applied for cooperatively determining a severity of the impact.

24. The system of claim 13 wherein the at least one sensor includes wheel-based sensors each located at a vehicle wheel measuring accelerations of the vehicle wheel, wherein the vehicle wheel incurring the impact is identified, wherein the at least one sensor further includes an inertial sensor measuring accelerations through a frame of the vehicle, wherein a redundant check is performed by determining whether the inertial sensor detected the impact to the vehicle, wherein if the determination is made that the acceleration sensed by a respective wheel-based sensor is greater than a maximum threshold and if the inertial sensor senses no impact, then a determination is made that a sensor error is present and the sensors are reset to continue monitoring for impacts.

25. The method of claim 13 wherein the at least one sensor includes wheel-based sensors each located at a vehicle wheel measuring accelerations of the vehicle wheel, wherein the vehicle wheel incurring the impact is identified, wherein the at least one sensor further includes an inertial sensor measuring accelerations through a frame of the vehicle, wherein a redundant check is performed by determining whether the inertial sensor detected an impact to the vehicle, wherein if the determination is made that the acceleration sensed by a respective wheel-based sensor is between a maximum threshold and a minimum threshold, then a tire pressure monitoring routine is applied for cooperatively determining a severity of the impact regardless of whether an impact was sensed by the inertial sensor.
